(19) United States
(12) Patent Application Publication
(10) Pub. No.: US 2008/0214304 A1
(43) Pub. Date: Sep. 4, 2008

(54) USER INTERFACE FOR SELECTING ITEMS IN A VIDEO GAME

(75) Inventor: Louis Castle, Las Vegas, NV (US)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronic Arts, Inc., Redwood City, CA (US)

(21) Appl. No.: 11/681,562

(22) Filed: Mar. 2, 2007

(51) Int. Cl. A63F 13/00

(52) U.S. Cl. 463/36

(57) ABSTRACT

In a computer program operating based on user inputs, a user input module receives user input from a view control portion of the user input device, the view control portion being input elements designated for user by the user to change a view, the view being a surface in a virtual space that is mapped to a display surface such that the user can see at least a portion of the contents of the virtual space that is visible through the view and the user can see different portions and/or perspectives of the virtual space by changing the view. The user view change inputs are conveyed to the computer program, thereby enabling the computer program to determine how to change a display to conform to the user's desired view change. The user input module can then receive user input to indicate a user's selection of objects from the virtual space and select objects in the virtual space using a current view as a selector for the items, thereby allowing the user to specify a selection by positioning a view. A reticle can be used to specify a viewable object to select and selection can be by matching categories of objects under the reticle.

### FIELD OF THE INVENTION

The present invention relates to user interfaces in general and more particularly to a user interface that accepts user inputs interactively to select items as part of a computer program that operates using user input.

### BACKGROUND OF THE INVENTION

Even with the most elegant and complex programs, if the user interface is not useful for the users of the programs, the programs will not enjoy widespread use. For example, doing calculations on business data had been done for years, but when the interface between the user and the calculations took the form of a spreadsheet, that genre of program really took off. From the user's perspective, the interface allows the user to interact with the program's output without having to “step out of the focus.”

As another example, prior to the development of web browsers, there were many tools for moving files from servers to clients, but the browser really boosted the number of users who wanted to move files. For the most part, the underlying protocols are the same (e.g., client requests a file, server provides the file, client does something with the file), but the user interface is quite different. Instead of calling up a program to transfer a file, saving the file, and then calling up another program to view the file, the user merely had to surf to the file of interest. Again, the user can interact with the output of programs without having to step out of focus and can interact within the interactive environment.

With video games increasing in complexity and making more demands on the reaction of players, the interface is important. As a result, cleverly laid out game controllers have been developed to allow the player to provide quick and varied input. As such, a game controller might have triggers, cursor movers, analog inputs, and various switches. For many games, such as first-person action games, such a game controller is sufficient—a player can use cursor movers to point, rotate and move the character and user other buttons to signal a player action such as a jump, shoot, duck, etc. However, where a game is more involved, interactions might be more difficult.

Consider a case where a player is controlling more than one character, such as all of the soccer players on a virtual soccer team or all of the soldiers in a virtual army. If the player were required to specify the moves of each individual character, the game play would be too slow, and would take the player out of the game while he or she “set up” the next “move.” Therefore, what is needed is intuitive and useful user interfaces to allow players to control game characters with a smooth flow to the game even where many characters are being controlled.

### BRIEF SUMMARY OF THE INVENTION

In a computer program operating based on user inputs, a user input module receives user input from a view control portion of the user input device, the view control portion being input elements designated for user by the user to change a view, the view being a surface in a virtual space that is mapped to a display surface such that the user can see at least a portion of the contents of the virtual space that is visible through the view and the user can see different portions and/or perspectives of the virtual space by changing the view. The user view change inputs are conveyed to the computer program, thereby enabling the computer program to determine how to change a display to conform to the user's desired view change. The user input module can then receive user input to indicate a user's selection of objects from the virtual space and select objects in the virtual space using a current view as a selector for the items, thereby allowing the user to specify a selection by positioning a view.

In another aspect, the user interface for a video game implemented in program code used for running the video game on a computing device receives user input from a view control portion of the user input device, the view control portion being input elements designated for user by the user to change a view, the view being a surface in a virtual space that is mapped to a display surface such that the user can see at least a portion of the contents of the virtual space that is visible through the view and the user can see different portions and/or perspectives of the virtual space on a display by changing the view. The displayed scene includes a reticle at a position in the view relative to the view such that a change in position of the view relative to the virtual space results in a change of position of the reticle relative to the virtual space and the current position of the reticle is used as a selection cursor, thereby allowing a user of the video game to select objects in the virtual space by changing the view and indicating a user's selection of objects from the virtual space based on what the reticle points to.

The following detailed description together with the accompanying drawings will provide a better understanding of the nature and advantages of the present invention.

### BRIEF DESCRIPTION OF THE DRAWINGS

FIG. 1 illustrates a game system for providing one or more games for a user according to one embodiment of the present invention.

FIG. 2 illustrates an embodiment of a game device according to the present invention.

FIG. 3 illustrates an example of data that may be stored in RAM to provide a game according to one embodiment of the present invention.

FIG. 4 is an illustration of virtual space occupied by virtual objects.

FIG. 5 is a representation of a display of a scene of the virtual space of FIG. 4.

FIG. 6 is a diagram illustrating a game controller having user inputs.

FIG. 7 is a flowchart of a process for accepting user input.

### DETAILED DESCRIPTION OF THE INVENTION

An improved video game interface is described herein. It should be understood that the video game interface might also find use in other interactive computer programs that are not considered video games but that have similar requirements for interfaces.

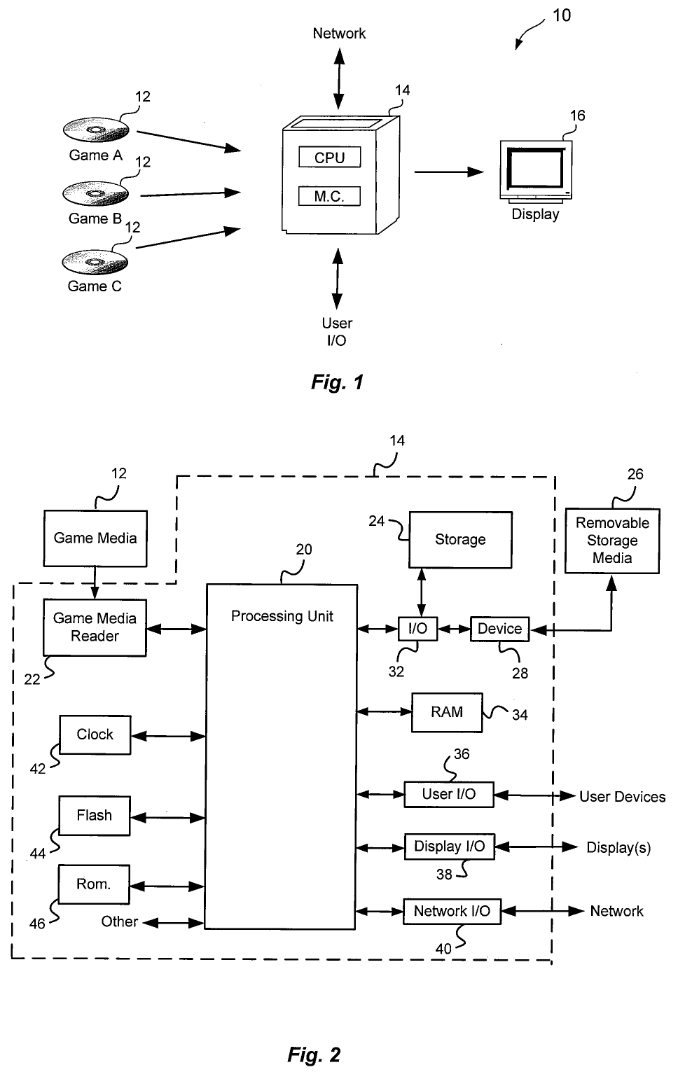

FIG. 1 illustrates a game system 10 for providing one or more games for a user according to one embodiment of the present invention. System 10 includes one or more game media 12 (game A, game B, game C), a game device 14, and a display 16 as well as interfaces for networks, user input/output (I/O) devices, etc.

One or more game media 12 include any game applications that may be used by game device 14 to provide a game for a user. Each game medium 12 includes logic to provide a game, denoted as game A, game B, game C. In one embodiment, the game provided by game device 14 is an electronic video game. Games are each individually stored on media, such as CDROMs, digital versatile disks (DVDs), game cartridges, or any storage media. A game, such as game A, is inserted in, coupled to, or in communication with game device 14 so that game device 14 may read a game application found on game media 12.

Game device 14 is a computing device that includes a central processing unit (“CPU”) and data storage. Game device 14 may be connected to a network that allows game device 14 to provide games that are not included on one or more game media 12. Thus, game A, game B, and game C may be accessed through the network and not be individually stored on game media 12. The games provided by game applications on game media 12 may output to display 16.

A game application may be also referred to as a game code and/or a game program. A game application will be understood to include software code that game device 14 uses to provide a game for a user to play. A user interacts with the game application and game device 14 through user input/output (P/O) devices. The game application is thus program code that includes instructions to receive user input from user I/O devices, change game state according to those inputs and rules of the game embodied in the program code, and output displays and other outputs according to the game state and rules of the game. For example, the game might be programmed such that a user input involving pressing a “Start” button changes from a game state of “Show Marquee and Menu” to a game state of “Initialize Play”.

The game state might be stored in device memory in the form of a collection of data and variables. For example, one component of game state might be the health levels of each character and another component might be a current view position. If the game code determines that a particular character has low health and the position of the particular character in a virtual game space is such that the character is visible from the position corresponding to the stored current view position, then the game program might output a scene for display that includes a representation of that character lying on the ground. Game state is described further below.

FIG. 2 illustrates an embodiment of game device 14 according to the present invention. It should be understood that other variations of game device 14 may be appreciated by a person of skill in the art. As shown, game device 14 includes a processing unit 20 that interacts with other components of game device 14 and also external components to game device 14. A game media reader 22 is included that communicates with game media 12. Game media reader 22 may be a CDROM or DVD unit that reads a CDROM, DVD, or any other reader that can receive and read data from game media 12.

Game device 14 also includes various components for enabling input/output, such as an I/O 32, a user I/O 36, a display I/O 38, and a network I/O 40. I/O 32 interacts with a storage 24 and, through a device 28, removable storage media 26 in order to provide storage for game device 14. Processing unit 20 communicates through I/O 32 to store data, such as game state data and any shared data files. In addition to storage 24 and removable storage media 26, game device 14 includes random access memory (RAM) 34. RAM 34 may be used for data that is accessed frequently, such as when a game is being played.

User I/O 36 is used to send and receive commands between processing unit 20 and user devices, such as game controllers. Display I/O 38 provides input/output functions that are used to display images from the game being played. Network I/O 40 is used for input/output functions for a network. Network I/O 40 may be used if a game is being played on-line or being accessed on-line.

Game device 14 also includes other features that may be used with a game, such as a clock 42, flash memory 44, read-only (ROM) 46, and other components. It will be understood that other components may be provided in game device 14 and that a person skilled in the art will appreciate other variations of game device 14.

As game device 14 reads game media 12 and provides a game, information may be read from game media 12 and stored in a memory device, such as RAM 34. Additionally, data from storage 24, ROM 46, servers through a network (not shown), or removable storage media 26 may be read and loaded into RAM 34. Although data is described as being found in RAM 34, it will be understood that data does not have to be stored in RAM 34 and may be stored in other memory accessible to processing unit 20 or distributed among several media, such as game media 12 and storage 24.

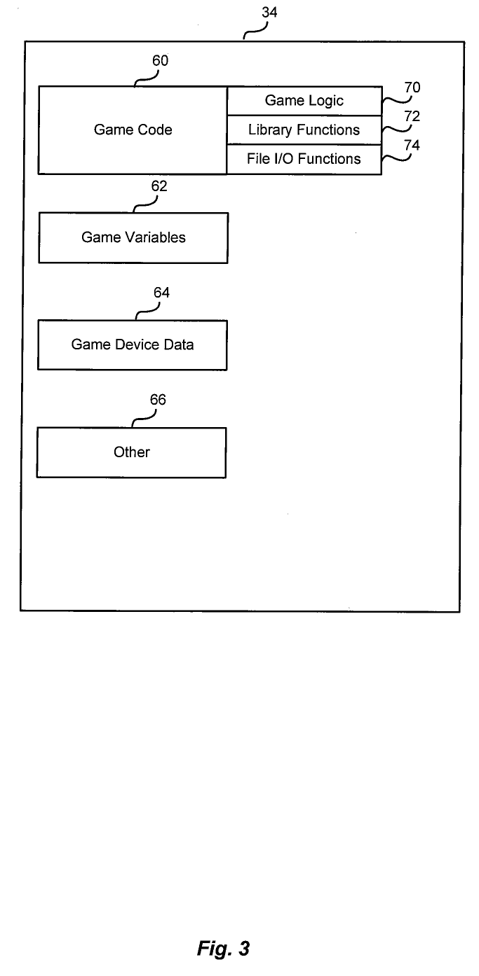

FIG. 3 illustrates an example of data that may be stored in RAM 34 to provide a game according to one embodiment of the present invention. For example, a game code 60, game variables 62, game device data 64, and other data 66 may be downloaded from game media 12 and stored in RAM 34. It will be understood that a person of skill in the art will appreciate other data that may be stored in RAM 34 that will enable game device 14 to provide the game.

Game code 60 may be any logic that is found on game media 12 that is used to provide a game. Game code 60 includes game logic 70, library functions 72, and file I/O functions 74. Game logic 70 is used to provide any functions of the game. Library functions 72 include any functions that are used to provide a game. File I/O functions 74 are used by processing unit 20 to perform input/output functions.

Game variables 62 are variables that are specific to a game and are used by processing unit 20 to provide variations of games for different users. The variables allow game device 14 to provide variations to the game based on actions by a user playing the game.

Game device data 64 is data specific to a game console that game code 60 is designed for. For example, different versions of game code 60 may be designed for different platforms supported by different game devices 14. Data specifically needed to operate game code 60 on a specific platform for a specific game device 14 may be included in game device data 64. Other data 66 may be any other data that is used with the game.

As a game found on game media 12 is played on game device 14, data regarding the state of the game and any other related aspect of the game may be generated. The game state data is then stored in storage, such as storage 24, removable storage media 26, RAM 34, or any other storage media accessible to game device 14. The game state data may then be used at another time by game device 14 to provide a game that is in the same state as when a user last played the game and saved its state. For example, the game state data may include data that allows a user to continue at a same level that the user has completed, data related to certain achievements that the user has accomplished, etc. It should be noted that the game state data does not necessarily start the game at the same exact place as the place when the game was last stopped but rather may start the game at a certain level or time related to when the game was last stopped or its state was saved.

Game variables might include, for example, view variables, character variables, selection variables, etc. View variables might include, for example, a view point, a view direction (or angle), a view rotation (or orientation), a view extent, cursor location(s), etc. Character variables might include, for example, an array of values for each character active in the game, state data on each character (e.g., name, health level, strength, possessions, alliances, type of character, etc.). Selection variables might include, for example, an array of selected objects.

As used herein, “object” is used to generally refer to logical units of a virtual game space. Examples of objects are trees, characters, clouds, buildings, backgrounds, buttons, tables, lights, etc. Each of these objects might be positioned in a virtual game space, typically a three-dimensional (“3D”) space to emulate actual experience. A view into this virtual game space can be defined by a view point, a view angle, a view extent, and possibly other view variables.

In a specific example, the objects are positioned by coordinates in a 3D coordinate system, the view point is a point in that coordinate system, the view direction is defined in the 3D coordinate system by a ray emanating from the view point, the view extent is a surface defined in the 3D coordinate system and what the game program displays is a graphical representation of the objects that are “visible” through the view extent from the view point. In a more specific example, the view extent is a planar rectangle oriented in the 3D coordinate space according to a view orientation and the planar rectangle corresponds with a rectangle of the display. Thus, what is displayed is a representation of the objects that happen to have coordinates that fall within the infinite pyramid defined by the edges of the planar rectangle and the view point. More precisely, what is often displayed are those objects that fall within a “view frustum” defined by a finite base of the pyramid (such as might be defined by an object that is the furthest back in a scene or a background) and the planar rectangle (thus excluding objects with coordinates that fall between the planar rectangle and the view point. It should be understood that other shapes of displays are possible and are not limited to rectangles, although that is a common example.

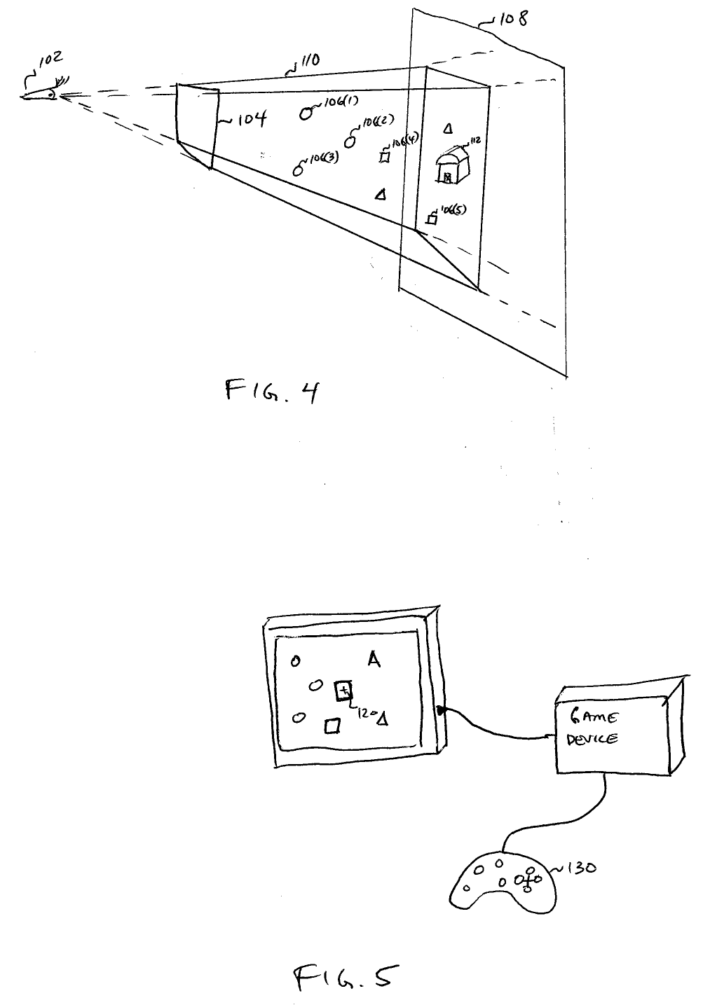

FIG. 4 is an illustration of virtual space occupied by virtual objects along the lines described above. That figure illustrates a view point 102, a view surface 104, a number of objects 106 positioned in the virtual space and a background 108. As illustrated, view point 102, view surface 104 and background 108 define a view frustum 110. More generally, view frustum is a viewable subspace and it is not required that the viewable subspace be divided from the rest of the virtual space by a frustum. In fact, view surface 104 might not be a rectangle and background 108 and view surface 104 might not be parallel. For example, if view surface 104 were a circle, then the viewable subspace might be described as a conic section. In fact, in some games and display systems, a perspective view is not used and there is no view point per se, but just a viewable subspace such as a rectangular prism.

In any case, the game program determines a viewable subspace and renders the objects that fall within that viewable subspace. A typical game allows the user to “look around” and move through the space, by altering the view point, view direction and view extent (e.g., zooming in/out) with the game program altering the display accordingly.

Some game objects might be “characters”, i.e., objects in the virtual space that can be manipulated, controlled or moved by the user or a counterpart that can be manipulated, controlled or moved by the computer program. For example, the barn 112 in the virtual space of FIG. 4 might be a non-character object, but a troll that is part of the game might be a character that the user can move around. In some multi-character games, there are multiple characters that a user can manipulate. For example, a soccer game might comprise 11 player characters, one of which is a goalie and the play of the game might require the user to quickly manipulate those 11 characters. In another example, an army might comprise archers, swordsmen, etc. all of who need to be moved as part of a strategy. Naturally, in a fast-paced strategy game, it might be cumbersome to require the user to move, activate and manipulate many different characters. For simplicity of illustration, some of the objects 106 in FIG. 4, such as objects 106(1)-(5) might be characters, with characters having different groupings (e.g., circles are one type of character, squares another and triangles yet another). More generally, a character might belong to one or more character category.

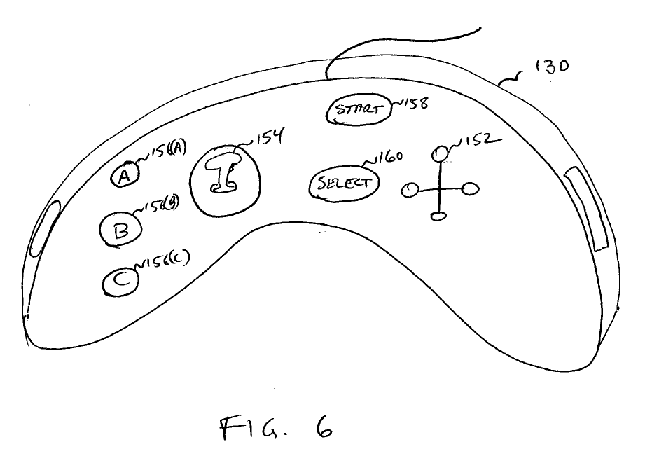

FIG. 5 illustrates what a display might look like if the view state where as shown in FIG. 4. In other words, FIG. 5 is an example of a display generated by the game program when the objects are in the positions shown in FIG. 4 and the view variables are as shown in FIG. 4. More precisely, the game program generates a scene, often represented by a rendered array of image pixels, from the game state (object positions, etc.) and outputs scene data to a display device that in turn displays the pixels corresponding to the scene. It should be understood that the game program may output a scene and assume that it is displayed and move to a next program step. Also shown in the scene is a “reticle” 120 that defines a current cursor position. In this description, the definition of reticle should not be limited, as it might be a cross-hairs pattern, a circle, a square, some non-geometric shape or feature, a dot or dots, line or lines, etc. Generally, a reticle is visible to the user or otherwise perceivable by the user and overlies some objects, objects or portions of a scene, wherein a scene is a view into a virtual game space managed by the game program.

FIG. 5 also shows a game controller 130 that provides user input. This is described in more detail below. Various controllers are possible, but a typical controller is a handheld device with multiple controls. Some of those controls might be dedicated in that they are used for the same function all the time, while others might be contextual and used for different functions depending on the current game state, however such details are not limiting for this description. In at least some game states, there are typically some controls for altering the user's view subspace.

The user's view subspace can be altered by translation, wherein the view point moves to different coordinates, by rotation about an axis (simulating the user turning his or her head in a first-person perspective game), changing orientation (e.g., rotating the view surface), or zooming (changing the view extent boundaries). There are well-known mechanisms to use user inputs to alter view subspaces.

FIG. 6 shows game controller 130 in greater detail, including button set 152, joystick 154, labeled buttons 156(A)-(C), a “Start” button 158 and a “Select” button 160. Depending on a game state, button set 152 might be used for the user to signal a translation or the like to change the user's current view while joystick 154 is used to change the user's orientation at the current view point. Again, this is just an example. Using whatever buttons or mechanism specified in the game, the user can change the view variables to change the current view.

In embodiments of the present invention, the user can select one or more objects by first setting a view that corresponds to the objects to be selected, then selecting the objects. In some embodiments, objects can be selected using the view and categorization of the objects. FIG. 5 illustrates an example of this. As shown there, an object of type “square” underlies reticle 120, so when selection is based on the view and the reticle position, then all objects (or some programmatically-determined set) of type “square” in the view are selected.

In some embodiments, the game program will provide for previewable actions or selections, wherein the game program indicates what is selected or what will happen and then provides the user a chance, after viewing the preview, to opt out of that action and/or selection.

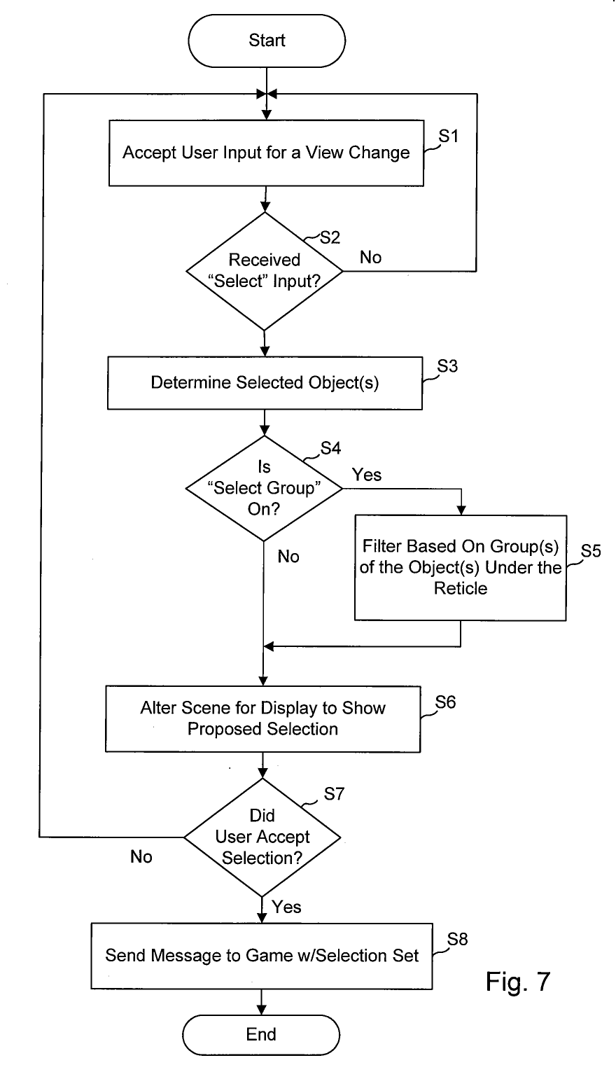

FIG. 7 is a flowchart of an example flow of an object selection and preview process. This is just an example and other processes might have different steps and/or in a different order. In this example, the steps are numbered for ease of reference S1, S2, etc. This process might be performed by a game device running a game program.

At step S1, the device accepts user input for view change. As an example, the game program might, among other loops of processes, accept user input, change a view, update a scene for display and perform other processing. The user input might be done using buttons on a game controller set aside for character movement, such as where the view is supposed to represent a current perspective of a first-person character, i.e., where the game is displaying what the character “sees” from the character's current location and orientation.

At step S2, the game program determines if the user has signaled a “Select” request. If not, the program continues to accept input and modify views accordingly. At step S3, the game program determines which objects are selected. In the basic example, all of the objects in the view subspace are the selected objects. In other examples, the selection subspace is somewhat different than the view subspace (e.g., slightly smaller) so that some visible items are not selected or vice versa.

At step S4, the game program determines whether a “Select Group” flag is on. Such a flag can be a game variable and perhaps alterable by the user using other input buttons. If the flag is on, then the program flows to step S5, wherein the visible objects are selected only if they have a category that matches the object under the reticle. For example, where the reticle is on an archer of a first division of an army, then only visible archers of the first division are selected. Some objects might have multiple categories, so an archer/cavalry rider might be part of the selected set. In some variations, there might be logic and inputs to allow for inversions of selections (e.g., select all characters other than the categories of the character under the reticle).

At step S6, whether all or a subset of visible objects are selected, the scene is displayed to show the proposed selection and then at step S7, the user can accept or reject the selection based on the user's review of what was selected, the action that is proposed to occur, or the like.

Finally, once a selection is made and confirmed, at step S8 a message is sent to a module of the game program to execute game steps based on the confirmed selection.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. A user input module for use with a computer program executed on a computing device having a user input device, the user input module providing user inputs from the user input device to the computer program, the user input module comprising:
logic for receiving user input from a view control portion of the user input device, the view control portion being input elements designated for user by the user to change a view, the view being a surface in a virtual space that is mapped to a display surface such that the user can see at least a portion of the contents of the virtual space that is visible through the view and the user can see different portions and/or perspectives of the virtual space by changing the view;
logic for conveying the user view change inputs to the computer program, thereby enabling the computer program to determine how to change a display to conform with the user's desired view change;
the user input module further comprising:
logic for receiving user input to indicate a user's selection of objects from the virtual space; and
logic for selecting objects in the virtual space using a current view as a selector for the items, thereby allowing the user to specify a selection by positioning a view.

2. The user input module of claim 1, wherein the view is a planar rectangle and the portion of the virtual space being viewed and used for selection is a frustum defined by a view point behind the view, the view, and objects in, and/or background, of the virtual space.

3. The user input module of claim 1, wherein the user input module is a module configured to receive view change inputs from input controller buttons designated for character movement within the virtual space and configured to receive a selection request from other input controller buttons.

4. The user input module of claim 1, further comprising a selection signalling module that provides the computer program with instructions to alter a display to indicate a view selection that is not entirely coincident with a boundary of a display and/or to indicate selected item.

5. The user input module of claim 1, wherein the computer program is a multi-character video game in which the user controls a plurality of characters of the video game within the virtual space, wherein a character is an object in the virtual space that can be manipulated, controlled or moved by the user or a counterpart that can be manipulated, controlled or moved by the computer program.

6. The user input module of claim 1, further comprising:
means for previewing a previewable action to be executed on a potentially selectable object, wherein an action is previewable if the user can view results of the action and subsequently decline to have the action taken by the computer program; and
means for indicating how to confirm the previewable action.

7. The intuitive control apparatus of claim 6, further comprising:
means for accessing at least one modal command, wherein the modal command is context sensitive based on the confirmed selection of potentially selectable objects.

8. A user interface for a video game implemented in program code used for running the video game on a computing device having a user input device, the user interface comprising:
logic for receiving user input from a view control portion of the user input device, the view control portion being input elements designated for user by the user to change a view, the view being a surface in a virtual space that is mapped to a display surface such that the user can see at least a portion of the contents of the virtual space that is visible through the view and the user can see different portions and/or perspectives of the virtual space on a display by changing the view;
logic for displaying a reticle at a position in the view relative to the view such that a change in position of the view relative to the virtual space results in a change of position of the reticle relative to the virtual space;
logic for using a current position of the reticle as a selection cursor, thereby allowing a user of the video game to select objects in the virtual space by changing the view; and
logic for receiving user input to indicate a user's selection of objects from the virtual space based on what the reticle points to.

9. The user interface of claim 8, wherein the reticle is represented by an image of cross-hairs.

10. The user interface of claim 8, wherein the reticle is represented by an image of a circle.

11. The user interface of claim 8, wherein the position in the view of the reticle is the center of the view, such that the reticle remains in the center of the display.

12. The user interface of claim 8, wherein the reticle is represented by a change in display of objects in the virtual space behind the reticle.

13. The user interface of claim 8, wherein the computer program is a multi-character video game in which the user controls a plurality of characters of the video game within the virtual space, wherein a character controlled by the user is an object in the virtual space that can be manipulated, controlled or moved by the user.

14. The user interface of claim 8, wherein the computer program is a multi-character video game in which the user controls a plurality of characters of the video game within the virtual space and the characters are categorized into a plurality of categories, wherein selection of a character using the reticle selects all or a predetermined subset of characters having a matching category.

15. A method of controlling operation of a computer program executed on a computing device having a user input device and an output device that has a display that can display a representation of a view of a virtual space according to the objects in the virtual space, a view position, a view extent and a view orientation, wherein the representation of the view corresponds to a surface in the virtual space that is mapped to a display surface such that the user can see at least a portion of the contents of the virtual space that is visible through the view and the user can see different portions and/or perspectives of the virtual space by changing one or more of the view position, view extent, view angle or view orientation, the method comprising:
accepting user inputs from a user input interface;
when the user inputs relate to a request to change a view, changing a view, wherein a change of view is one or more of a change of view position representing the user's apparent position in the virtual space, a change of view extent representing the extent of the view in the virtual space, a change of view angle representing the apparent direction in the virtual space the user is looking, and a change of view orientation representing the user's apparent rotational position in the virtual space;
updating the display to reflect the change of view;
when the user inputs relate to a selection request, determining a current view; and
selecting selectable objects in the virtual space based on the current view, thereby allowing the user to specify selections of objects by the user changing the current view prior to indicating the selection request.

16. The method of claim 15, wherein the view is a planar rectangle and the portion of the virtual space being viewed and used for selection is a frustum defined by a view point behind the view, the view, and objects and/or background of the virtual space present in that frustum.

17. The method of claim 15, wherein accepting user inputs comprises accepting user inputs from input controller buttons designated for character movement within the virtual space and wherein the selection request is indicated using other input controller buttons.

18. The method of claim 15, further comprising altering the display to indicate a selection portion of the current view when the selection portion is not entirely coincident with a boundary of a display and/or to indicate selected items.

19. The method of claim 15, wherein the computer program is a multi-character video game in which the user controls a plurality of characters of the video game within the virtual space, wherein a character is an entity, object or other unit that can be manipulated, controlled or moved by the user or the computer program.

20. The method of claim 15, further comprising:
displaying effects of a previewable action to be executed on a potentially selectable object, wherein an action is previewable if the user can view results of the action and subsequently decline to have the action taken by the computer program; and
accepting input for confirming or not confirming the previewed action

21. The method of claim 15, further comprising accessing at least one modal command, wherein the modal command is context sensitive based on the confirmed selection of potentially selectable objects.

22. A method of controlling operation of a computer program executed on a computing device having a user input device and an output device that has a display that can display a representation of a view of a virtual space according to the objects in the virtual space, a view position, a view extent and a view orientation, wherein the representation of the view corresponds to a surface in the virtual space that is mapped to a display surface such that the user can see at least a portion of the contents of the virtual space that is visible through the view and the user can see different portions and/or perspectives of the virtual space by changing one or more of the view position, view extent, view angle or view orientation, the method comprising:
receiving user input from a view control portion of the user input device, the view control portion being input elements designated for user by the user to change a view;
displaying a reticle at a position in the view relative to the view such that a change in position of the view relative to the virtual space results in a change of position of the reticle relative to the virtual space;
using a current position of the reticle as a selection cursor, thereby allowing a user of the video game to select items in the virtual space by changing the view; and
receiving user input to indicate a user's selection of items from the virtual space based on what the reticle points to.

23. The method of claim 22, wherein the reticle is represented by an image of cross-hairs.

24. The method of claim 22, wherein the reticle is represented by an image of a circle.

25. The method of claim 22, wherein the position in the view of the reticle is the center of the view, such that the reticle remains in the center of the display.

26. The method of claim 22, wherein the reticle is represented by a change in display of objects in the virtual space behind the reticle.
